(19) United States
(12) Patent Application Publication
(10) Pub. No.: US 2026/0003479 A1
(43) Pub. Date: Jan. 1, 2026

(54) SEMANTIC LAYER FOR DATA VISUALIZATION SYSTEMS

(71) Applicant: Sequoia Benefits and Insurance Services, LLC, San Mateo, CA (US)

(72) Inventor: Kamal Bannuru, Bangaluru (IN)

(21) Appl. No.: 18/755,282

(22) Filed: Jun. 26, 2024

(51) Int. Cl. G06F 3/0484

(52) U.S. Cl. CPC G06F 3/0484

(57) ABSTRACT

A method includes receiving, by a semantic layer executed by a processing device, a first indication identifying an initialization, at a user device, of an instance of a graphical user interface (GUI) comprising one or more GUI elements; responsive to receiving the first indication, determining first semantic layer data associated with a first one or more data categories specific to a first GUI element of the one or more GUI elements; causing an execution of a database query to retrieve first data of the first one or more data categories associated with the first semantic layer data; generating a blended table comprising the first data of the first one or more data categories based on the first semantic layer data; and providing the first data from the blended table to render the first GUI element of the GUI for presentation at the user device.

### TECHNICAL FIELD

Aspects and embodiments of the disclosure relate to data processing, and more specifically, to an improved semantic layer for data visualization systems.

### BACKGROUND

Many organizations use computer-generated dashboards to visualize data. Generating such dashboards often includes retrieving the data to be visualized from data storage and providing the data to a graphic user interface component to generate the visualizations of the data.

### SUMMARY

Disclosed herein are systems and methods for an improved semantic layer for data visualization systems. One aspect of the disclosure includes a method. The method includes receiving, by a semantic layer executed by a processing device, a first indication identifying an initialization, at a user device, of an instance of a graphical user interface (GUI) that includes one or more GUI elements. The method includes, responsive to receiving the first indication, determining first semantic layer data associated with a first one or more data categories specific to a first GUI element of the one or more GUI elements. The method includes causing an execution of a database query to retrieve first data of the first one or more data categories associated with the first semantic layer data. The method includes generating a blended table including the first data of the first one or more data categories based on the first semantic layer data. The method includes providing the first data from the blended table to render the first GUI element of the GUI for presentation at the user device.

In one embodiment, the first semantic layer may data specify the first one or more data categories specific to the first GUI element, rather than other data categories that are unspecific to the first GUI element.

In some embodiments, the method may further include, responsive to receiving the first indication, determining second semantic layer data associated with a second one or more data categories specific to a second GUI element of the one or more GUI elements. The method may further include causing an execution of another database query to retrieve second data of the second one or more data categories associated with the second semantic layer data; The method may further include appending the blended table to include the second data of the second one or more data categories based on the second semantic layer data. The method may further include providing the second data from the blended table to render the second GUI element of the GUI for presentation at the user device.

In one or more embodiments, the method may further include, responsive to receiving the first indication, identifying GUI configuration data to configure the GUI specified by the first indication, the GUI configuration data identifying the one or more GUI elements of the GUI.

In one embodiment, the method may further include receiving a second indication identifying a user request to render a third GUI element of the one or more GUI elements based on one or more user-selected parameters corresponding to a third data category and a fourth data category. The method may further include responsive to receiving the second indication, determining, by the semantic layer, whether the third data category and the fourth data category are compatible. The method may further include, responsive to determining that the third data category and the third data category are incompatible, providing third data corresponding to the third data category to render the third GUI element of the GUI for presentation at the user device, and refraining from providing fourth data corresponding to the fourth data category.

In some embodiments, a GUI element of the one or more GUI elements may include at least one of a chart or a table. In one embodiment, determining the first semantic layer data may include identifying the first semantic layer data based on the first indication, and the first semantic layer data may specify the first one or more data categories to generate the database query.

In one or more embodiments, determining the first semantic layer data may include: determining the first one or more data categories specific to the first GUI element, identifying database metadata corresponding to the first one or more data categories, identifying, at runtime using metadata of a database, one or more database tables that include the first one or more data categories, and generating the database query to retrieve the first data of the first one or more data categories from the identified one or more database tables.

Another aspect of the disclosure includes a system that includes a memory and a processing device coupled to the memory. The processing device is configured to perform operations. The operations may include receiving, by a semantic layer executed by a processing device, a first indication identifying an initialization, at a user device, of an instance of a GUI that includes one or more GUI elements. The operations may include, responsive to receiving the first indication, determining first semantic layer data associated with a first one or more data categories specific to a first GUI element of the one or more GUI elements. The operations may include causing an execution of a database query to retrieve first data of the first one or more data categories associated with the first semantic layer data. The operations may include generating a blended table that includes the first data of the first one or more data categories based on the first semantic layer data. The operations may include providing the first data from the blended table to render the first GUI element of the GUI for presentation at the user device.

In one embodiment, the first semantic layer data may specify the first one or more data categories specific to the first GUI element, rather than other data categories that are unspecific to the first GUI element.

In one or more embodiments, the operations may further include, responsive to receiving the first indication, determining second semantic layer data associated with a second one or more data categories specific to a second GUI element of the one or more GUI elements. The operations may further include causing an execution of another database query to retrieve second data of the second one or more data categories associated with the second semantic layer data. The operations may further include appending the blended table to include the second data of the second one or more data categories based on the second semantic layer data. The operations may further include providing the second data from the blended table to render the second GUI element of the GUI for presentation at the user device.

In some embodiments, the operations may further include, responsive to receiving the first indication, identifying GUI configuration data to configure the GUI specified by the first indication, the GUI configuration data identifying the one or more GUI elements of the GUI.

In one embodiment, the operations may further include receiving a second indication identifying a user request to render a third GUI element of the one or more GUI elements based on one or more user-selected parameters corresponding to a third data category and a fourth data category. The operations may further include, responsive to receiving the second indication, determining, by the semantic layer, whether the third data category and the fourth data category are compatible. The operations may further include, responsive to determining that the third data category and the third data category are incompatible, providing third data corresponding to the third data category to render the third GUI element of the GUI for presentation at the user device, and refraining from providing fourth data corresponding to the fourth data category.

In one or more embodiments, a GUI element of the one or more GUI elements may include at least one of a chart or a table. In some embodiments, determining the first semantic layer data may include identifying the first semantic layer data based on the first indication, and the first semantic layer data may specify the first one or more data categories to generate the database query.

In some embodiments, determining the first semantic layer data may include: determining the first one or more data categories specific to the first GUI element, identifying database metadata corresponding to the first one or more data categories, identifying, at runtime using metadata of a database, one or more database tables that include the first one or more data categories, and generating the database query to retrieve the first data of the first one or more data categories from the identified one or more database tables.

Another aspect of the disclosure includes a non-transitory computer-readable storage medium that includes instructions that, responsive to execution by a processing device, cause the processing device to perform operations. The operations may include receiving, by a semantic layer executed by a processing device, a first indication identifying an initialization, at a user device, of an instance of a GUI that includes one or more GUI elements. The operations may include, responsive to receiving the first indication, determining first semantic layer data associated with a first one or more data categories specific to a first GUI element of the one or more GUI elements. The operations may include causing an execution of a database query to retrieve first data of the first one or more data categories associated with the first semantic layer data. The operations may include generating a blended table that includes the first data of the first one or more data categories based on the first semantic layer data. The operations may include providing the first data from the blended table to render the first GUI element of the GUI for presentation at the user device.

In some embodiments, the first semantic layer data may specify the first one or more data categories specific to the first GUI element, rather than other data categories that are unspecific to the first GUI element.

In one embodiment, the operations may further include, responsive to receiving the first indication, determining second semantic layer data associated with a second one or more data categories specific to a second GUI element of the one or more GUI elements. The operations may further include causing an execution of another database query to retrieve second data of the second one or more data categories associated with the second semantic layer data. The operations may further include appending the blended table to include the second data of the second one or more data categories based on the second semantic layer data. The operations may further include providing the second data from the blended table to render the second GUI element of the GUI for presentation at the user device.

In one or more embodiments, the operations may further include, responsive to receiving the first indication, identifying GUI configuration data to configure the GUI specified by the first indication. The GUI configuration data may identify the one or more GUI elements of the GUI.

### BRIEF DESCRIPTION OF THE DRAWINGS

Aspects and embodiments of the present disclosure will be understood more fully from the detailed description given below and from the accompanying drawings of various aspects and embodiments of the disclosure, which, however, should not be taken to limit the disclosure to the specific aspects or embodiments, but are for explanation and understanding only.

FIG. 1 schematically illustrates an example architecture, in accordance with some embodiments of the disclosure.

FIG. 2 schematically illustrates another example architecture, in accordance with some embodiments of the disclosure.

FIG. 3 schematically illustrates an example dataflow to generate a blended table by using semantic layer data, in accordance with some embodiments of the disclosure.

FIG. 4A illustrates a first portion of example GUI configuration data, in accordance with some embodiments of the disclosure.

FIG. 4B illustrates a second portion of the example GUI configuration data, in accordance with some embodiments of the disclosure.

FIG. 5A illustrates a first portion of example semantic layer data, in accordance with some embodiments of the disclosure.

FIG. 5B illustrates a second portion of the example semantic layer data, in accordance with some embodiments of the disclosure.

FIG. 6 schematically illustrates an example dataflow to determine data compatibility by using semantic layer data, in accordance with some embodiments of the disclosure.

FIG. 7A illustrates an example GUI element including a line chart, in accordance with some embodiments of the disclosure.

FIG. 7B illustrates another example GUI element including a line chart, in accordance with some embodiments of the disclosure.

FIG. 8 depicts a flowchart illustrating an example method for practicing some embodiments of the disclosure.

FIG. 9 depicts a flowchart illustrating another example method for practicing some embodiments of the disclosure.

FIG. 10 schematically illustrates an example computer system, in accordance with some embodiments of the disclosure.

### DETAILED DESCRIPTION

Organizations can use various services such as software-as-a-service (SaaS) services to collect, analyze, utilize, and visualize data. Visualizing the data can include a SaaS service providing a dashboard with various visualizations (e.g., graphs, charts, tables, etc.) based on the data. As part of the process of generating a visualization for a dashboard, the SaaS service generates a database query that retrieves data used to generate the visualization. The database query (1) specifies the database tables that contain the data needed for the requested visualization, (2) joins the specified tables, in their entireties, into one large table, and (3) retrieves data from the large table that meets retrieval criteria specified in the database query.

The above visualization process has several disadvantages. For example, the one large table created by joining multiple database tables is often very large in size (with potentially hundreds of columns and thousands of rows), and storing the table in the memory (e.g., volatile memory) of the computing device running the database occupies a significant amount of memory resources. In some instance, the table(s) is/are too large to be stored in memory and, thus, is/are stored in non-volatile storage, which can add to latency in retrieval of the table data. Additionally, because of the large size of the table, retrieving data from the table takes a significant amount of time and computing resources.

Aspects and embodiments of the present disclosure address the above deficiencies, among others, by providing a semantic layer that generates blended tables that are smaller and more efficient to operate on than the large table of conventional data visualization systems. A semantic layer may include a representation of an organization's data that assists other SaaS services components in requesting and obtaining the organization's data without needing to know about or interact with the data storage implementation of the SaaS services. The semantic layer may include software components that receive requests for data from other components of the SaaS services, execute one or more operations to obtain the requested data, and provide the requested data to the requesting SaaS services component(s).

Aspects and embodiments of the present disclosure receive, by the semantic layer executing at the SaaS services, a first indication that identifies the initialization of an instance of a graphical user interface (GUI) that includes a first GUI element. The initialization of the GUI may have been provided by a user device used by a user of the SaaS services. The first GUI element can include a visualization, such as a chart or a table. Responsive to receiving the first indication, the SaaS services may determine first semantic layer data associated with a first one or more data categories specific to the first GUI element. The first semantic layer data can specify data categories used to generate the first GUI element. A data category can refer to a group or type of data that is organized, calculated, or generated based on one or more shared characteristics or functions. Examples of data categories include database columns, calculated data, and metrics. The SaaS services can cause the execution of a database query that retrieves first data of the first one or more data categories associated with the first semantic layer data. Executing the database query may include generating a blended table that includes the first data, and, as stated above, the blended table is smaller than the one large table generated by conventional data visualization systems. The SaaS services may retrieve the first data from the blended table and provide the first data to render the first GUI element at the user device.

For example and in some embodiments, the SaaS services can receive an indication of a GUI initialization at a client device. The GUI can include one or more charts or graphs (e.g., GUI elements). Responsive to the indication, the SaaS services can retrieve GUI configuration data that identifies information pertaining to the configuration of the GUI. For example, the GUI configuration data can identify the charts and graphs (e.g., GUI elements) presented in the GUI as well as one or more search queries for additional data displayed outside the GUI elements (e.g., user account information, menu information, date information, etc.). The GUI element identifier of the GUI configuration data can be used to retrieve semantic layer data. In some cases, each GUI element can include specific semantic layer data that identifies the data categories for a particular GUI element. The data categories can indicate the particular table columns to retrieve and the metrics to calculate, for example. In some embodiments, the semantic layer data can include an application programming interface (API) call (e.g., an internal API call) for a database query to obtain the relevant data for the particular GUI element (without additional superfluous data). Using the semantic layer data, a database query can be performed to obtain the relevant data and any calculation on the retrieved data can be performed. The retrieved data, calculated data, and/or metrics can be stored in memory in a blended table and provided for formatting and display in the GUI, and in particular, in one or more GUI elements rendered as charts, graphs, and so forth.

In another example and in one or more embodiments, the SaaS services can, again, receive an indication of a GUI initialization at a client device. The indication may include data identifying one or more data categories used to render GUI elements of the GUI. Responsive to the indication, the SaaS services may, at runtime, use database metadata to determine which database tables include the one or more data categories identified in the indication. For example, database metadata may specify, for each database table, the columns included in the respective database table. The SaaS services may then generate a database query to obtain the relevant data and perform any calculation on the retrieved data. The retrieved data, calculated data, and/or metrics can be stored in memory in a blended table and provided for formatting and display in the GUI, and in particular, in one or more GUI elements rendered as charts, graphs, and so forth.

In another example and in some embodiments, the SaaS services can receive an indication that identifies a user request to render a GUI element. The indication may include a user-selected parameter, which may include a filter on a data category used to render the GUI element. The SaaS services can use compatibility data to determine whether one or more data categories used to render the GUI element are compatible in light of the user-selected parameter. Responsive to the SaaS services determining that the one or more data categories are incompatible, the SaaS services may generate a database query that obtains some of the relevant data. The SaaS services can perform calculations on the retrieved data and store the retrieved data, calculated data, and/or metrics in memory in a table and provide the table for formatting and display in the GUI (instead of, as with conventional SaaS services, not rendering the GUI element at all and producing an error message). Responsive to the SaaS services determining that the one or more data categories are compatible, the SaaS services may generate a different database query that obtains the relevant data. The SaaS services can perform calculations on the retrieved data and store the retrieved data, calculated data, and/or metrics in memory in a blended table and provide the table for formatting and display in the GUI.

In addition, some benefits of the present disclosure may provide a technical effect caused by or resulting from a technical solution to a technical problem. For example, one technical problem may relate to the large size of the one large table in memory. One of the technical solutions to the technical problem may include creating the blended table, which is smaller in size. Another technical problem may relate to retrieving data from the large table, which, due to its size, is slow and inefficient. One of the technical solutions to this technical problem includes retrieving data from the blended table, which is smaller. As a consequence, memory usage and retrieval times are reduced, and computing resource usage is more efficient.

As used herein, an “organization” can refer to an entity, such as a legal entity that includes multiple people (e.g., organization personnel) that has a particular purpose. Examples of organizations can include government agencies, non-profits, corporations (e.g., authorized by law to act as a single entity or legal entity) and partnerships. Multiple organizations can describe one or more organizations that are independent or distinct from the other organizations of the multiple organizations. For example, a first organization can be corporation A and a second organization can be corporation B. Corporation A can be considered an independent legal entity from corporation B. Each of corporation A and corporation B make independent decisions, have a different hierarchical structure, and use different job titles. A department (or sub-department) can refer to a group within an organization that contributes to an organization's mission or goals. In some embodiments, departments of an organization can be based on the function the department serves within the organization. For example, departments of an organization can include research and development (R&D), Marketing, Legal, Human Resources, Accounting, among other. Each of the various departments can include one or more individuals that perform the function of the respective department.

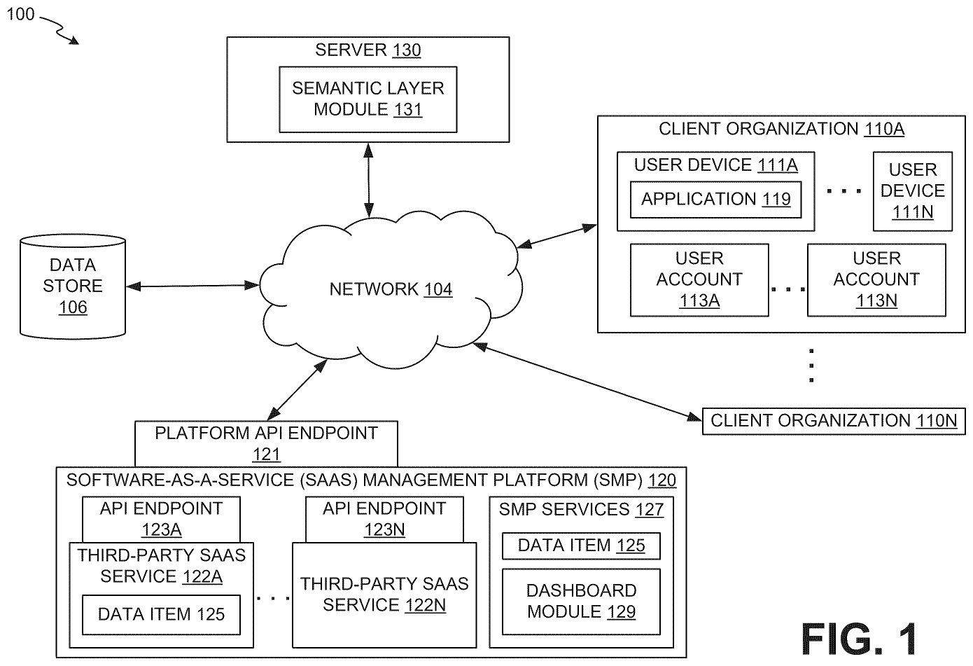

FIG. 1 schematically illustrates an example architecture 100, in accordance with some embodiments of the disclosure. The architecture 100 (also referred to as “system 100” herein) includes a software-as-a-service (SaaS) management platform 120 (also referred to herein as “SaaS management platform 120”), a server 130, a data store 106, and one or more client organizations 110A-N connected to network 104. In some embodiments, architecture 100 can include one or more third-party platforms (not shown).

In some embodiments, network 104 can include a public network (e.g., the Internet), a private network (e.g., a local area network (LAN) or wide area network (WAN)), a wired network (e.g., Ethernet network), a wireless network (e.g., an 802.11 network or a wireless fidelity (Wi-Fi) network), a cellular network (e.g., a Long Term Evolution (LTE) network), routers, hubs, switches, server computers, and/or a combination thereof.

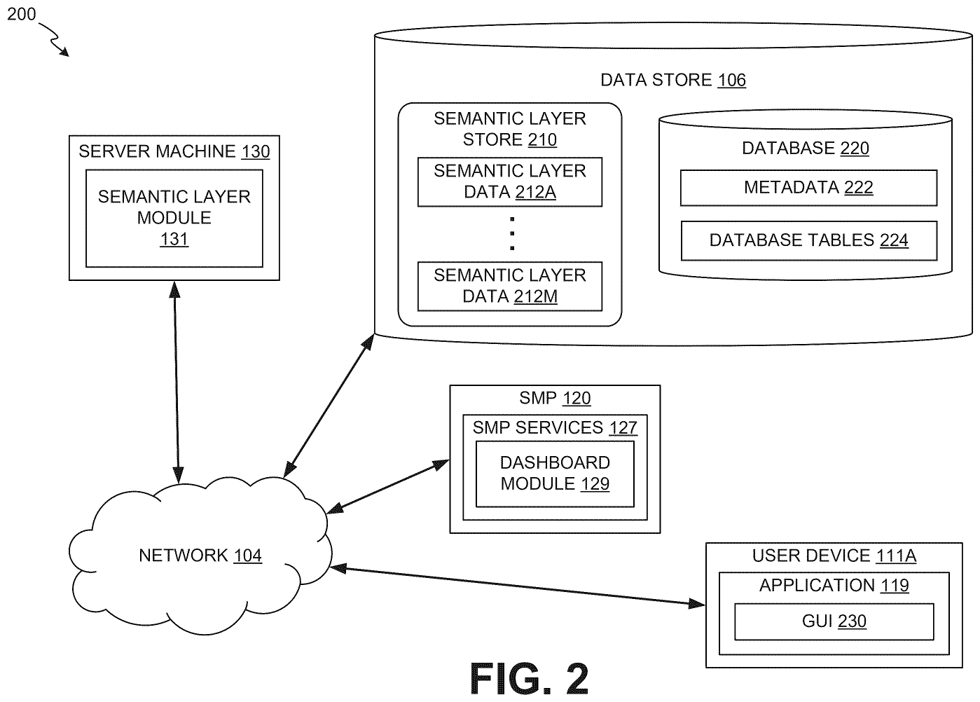

Data store 106 can be a persistent storage that is capable of storing information. Data store 106 can be hosted by one or more storage devices, such as main memory, magnetic or optical storage-based disks, tapes or hard drives, network-attached storage (NAS), storage area network (SAN), and so forth. In some embodiments, data store 106 can be a network-attached file server, while in other embodiments the data store 106 can be another type of persistent storage such as an object-oriented database, a relational database, and so forth, that can be hosted by SaaS management platform 120, or one or more different machines coupled to the server hosting the SaaS management platform 120 via the network 104. In some embodiments, data store 106 can be capable of storing one or more data items 125, as well as data structures to tag, organize, and index the data items 125. A data item 125 can include various types of data including structured data, unstructured data, or types of digital files, including text data, audio data, image data, video data, multimedia, interactive media, data objects, and/or any suitable type of digital resource, among other types of data. An example of a data item 125 can include a file, database record, programming code, or document, among others. Further information about types of data stored in data store 106 are described with reference to FIG. 2.

A client organization (e.g., a client organization 110) can refer to an organization that uses the services provided by the SaaS management platform 120. The client organizations 110A-N can each include one or more computing devices such as personal computers (PCs), laptops, mobile phones, smart phones, tablet computers, netbook computers, network-connected televisions, etc. In some embodiments, a client organization 110 can include user devices 111A-N which may also be referred to as “client devices.”

In some embodiments, SaaS management platform 120 can provide one or more organizational accounts (not shown) that are assigned to a particular organization, such as a client organization 110A. For example, corporation A can be assigned organizational account A. In some embodiments, SaaS management platform 120 can provide an organizational account with one or more user accounts. For example, organizational account A can be a root account and user accounts 113A-113N can be under the root account in a hierarchical structure. In some embodiments, a client organization 110 (or SaaS management platform 120) can assign user accounts 113A-N to respective users within the organization. User accounts 113A-N (also generally referred to herein as “user account 113”) can be used to access SaaS management platform 120 via user devices 111A-N. A “user” can be an individual of the organization associated with a respective user account 113. In some embodiments, aspects of the disclosure encompass a “user” being an entity controlled by a group of organization personnel and/or an automated source. For example, a group of organization personnel federated as one or more departments in an organization can be considered a “user.” Each user account 113 can be assigned authorization credentials to access the SaaS management platform 120 (e.g., a username and password) and further use authentication credentials (e.g., an access token, etc.) to access specific services provided thereby. In some embodiments, user accounts 113A-N can include enhanced privileges (e.g., administrator accounts, information technology (IT) specialist accounts, etc.).

The SaaS management platform 120 can be a platform that can provide services to one or more client organizations 110A-N. The SaaS management platform 120 can be accessible, at least in part, by one or more user accounts 113A-N provided or assigned to client organization 110 by SaaS management platform 120. As described above, a user account 113 can access the SaaS management platform 120 by providing authentication credentials via an application on a user device 111 of the client organization 110. The SaaS management platform 120 can provide one or more services to a user device 111 associated with the user accounts 113 that has provided proper authentication credentials.

In some embodiments, the SaaS management platform 120 can include one or more third-party SaaS services 122A-N. In some embodiments, the SaaS management platform 120 can include one or more first-party services, illustratively shown as SaaS management platform services 127. When a user device 111 associated with a user account 113 accesses the SaaS management platform 120, the SaaS management platform 120 can provide the user device 111 with access to one or more services (e.g., one or more third-party SaaS services 122A-N) based on the particular service authorization associated with the user account. One or more data item(s) 125 can be accessed via the authorized services. In some embodiments, the user device 111 can access the data item 125 using one or more of the SaaS management platform services 127. In some embodiments, the user device 111 can access the data item 125 using one or more third-party SaaS services 122. The user device 111 receives a data item 125 from the SaaS management platform 120 in response to a request for the data item. In some embodiments, the SaaS management platform 120 can function as a “black box” with respect to the user device 111. That is, regardless of the original source of the data item 125 (e.g., whether from the SaaS management platform service 127, or from one or more third-party SaaS services 122A-N) the user device 111 can receive the data item 125 as if the data item 125 originated from the SaaS management platform 120. For example, the SaaS management platform 120 can include a third-party SaaS service 122 that digital resource management services to a client organization 110, or the functionality to deploy services of the third-party SaaS service 122 such as software applications to a client organization 110 for an on-demand service. In another example, the SaaS management platform can include a third-party SaaS service 122 that can deliver and/or license software applications on a subscription basis while the third-party SaaS service 122 hosts, at least in part, the software application. In some embodiments, the licensed software applications can, at least in part, be hosted on the infrastructure, such as the cloud computing resources of the third-party SaaS service 122. Examples of software applications provided to the SaaS management platform by one or more third-party SaaS services 122 can include a database management SaaS service, a software suite SaaS service, a human resources SaaS service, etc.

A third-party can refer to an entity, such as an enterprise or organization (e.g., third-party SaaS service provider) that is distinct and/or external from a first-party entity, such as the SaaS management platform 120. In some embodiments, the third-party SaaS service(s) can be offered to the client organization 110A in a manner that is opaque to the users of an client organization 110A, such that access to any SaaS services (first-party or third-party) appears to the users as an access of the SaaS management platform 120.

In the illustrated example, a user device 111 can access the SaaS management platform 120 through network 104 using one or more API calls via platform API endpoint 121. In some embodiments, SaaS management platform 120 can include multiple platform API endpoints 121 that can expose services, functionality, or services of the SaaS management platform 120 to one or more user devices 111A-N of a client organization 110. In some embodiments, a platform API endpoint 121 can be one end of a communication channel, where the other end can be another system, such as a user device 111 associated with a user account 113 of a client organization 110. In some embodiments, the platform API endpoint 121 can include or be accessed using a resource locator, such a universal resource identifier (URI), universal resource locator (URL), of a server or service. The platform API endpoint 121 can receive requests from other systems, and in some cases, return a response with information responsive to the request. In some embodiments, HTTP or HTTPS methods (e.g., API calls) can be used to communicate to and from the platform API endpoint 121.

In some embodiments, the platform API endpoint 121 can function as a computer interface through which access requests are received and/or created. In some embodiments, the platform API endpoint 121 can include a platform API whereby external entities or systems can request access to services and/or data items 125 provided by the SaaS management platform 120. The platform API can be used in programmatically obtaining one or more data items 125 associated with a request for services and/or data items 125. In some embodiments, the platform API is implemented in connection with a multitenant communication service wherein different accounts (e.g., authenticated entities such as user accounts 113A-N) can submit independent requests. These requests made using API calls via Platform API endpoint 121 can be managed with consideration of other requests made within a user account 113 and/or across multiple user accounts (e.g., user accounts 113A-N) on the SaaS management platform 120.

In some embodiments, the API of the platform API endpoint 121 can be any suitable type of API such as a REST (Representational State Transfer) API, a GraphQL API, a SOAP (Simple Object Access Protocol) API, and/or any suitable type of API. In some embodiments, the SaaS management platform 120 can expose through the API, a set of API resources which when addressed can be used for requesting different actions, inspecting state or data, and/or otherwise interacting with the SaaS management platform 120. In some embodiments, a REST API and/or another type of API can work according to an application layer request and response model. An application layer request and response model can use HTTP (Hypertext Transfer Protocol), HTTPS (Hypertext Transfer Protocol Secure), SPDY, or any suitable application layer protocol. Herein HTTP-based protocol is described for purposes of illustration rather than limitation. The disclosure should not be interpreted as being limited to the HTTP protocol. HTTP requests (or any suitable request communication) to the SaaS management platform 120 can observe the principles of a RESTful design or the protocol of the type of API. RESTful is understood in this document to describe a Representational State Transfer architecture. The RESTful HTTP requests can be stateless, thus each message communicated contains all necessary information for processing the request and generating a response. The API service can include various resources, which act as endpoints that can specify requested information or requesting particular actions. The resources can be expressed as URI's or resource paths. The RESTful API resources can additionally be responsive to different types of HTTP methods such as GET, PUT, POST and/or DELETE.

In some embodiments, the platform API endpoint 121 can include an access request instruction module (e.g., access request module) that can be called within an application, script, or other computer instruction execution. For example, a computing platform can support the execution of a set of program instructions where at least one instruction within a script or other application logic is used in specifying an access request and communicating that request. In some embodiments, the platform API endpoint 121 can include a console, administrator interface, or other suitable type of user interface. Such a user-facing interface can be a graphical user interface (GUI). Such a user interface can additionally work in connection with a programmatic interface.

In some embodiments, the platform API request (e.g., API call to platform API endpoint 121) can include a data object characterizing the properties of one or more services and/or data items 125 to be accessed. In some embodiments, the platform API request can be associated with other API requests (e.g., API calls to API endpoints 123A-N) that are programmatically initiated by SaaS management platform 120 (e.g., via SaaS management platform services 127). In some embodiments, the platform API request can be initiated from another (e.g., previous) access request. In some embodiments, service API requests to API endpoints 123A-N can be programmatically initiated from platform API requests to platform API endpoint 121. For example, the SaaS management platform 120 can receive a platform API request for a data item 125 that is provided by or hosted on a third-party SaaS service 122. The SaaS management platform services 127 can programmatically initiate a service API request to the API endpoint 123A-N of the respective one or more third-party SaaS services 122A-N corresponding to the requested data item 125. In some embodiments, the SaaS management platform 120 can offer third-party services (and first-party services) by making only platform API requests (received through platform API endpoint 121) available to end users (e.g., users of user accounts 113A-N).

In the illustrated example, a user device 111 associated with a user account 113 can send a platform API request to the SaaS management platform 120 for a data item 125 through platform API endpoint 121. The platform API request can be processed by the SaaS management platform 120 at platform API endpoint 121. Based on the contents or nature of the request, the SaaS management platform 120 can determine the source of the data item 125 that has been requested by the client device (e.g., by using SaaS management platform service 127). If the data item 125 is available from the SaaS management platform service 127 then the SaaS management platform 120 can provide the data item 125 to the user device 111 without making a third-party API call to an API endpoint 123A-123N. If the data item 125 is available from a third-party SaaS service 122, the SaaS management platform 120 can generate and send a service API request to the respective third-party SaaS service 122A-N through the corresponding API endpoint 123A-N. Responsive to receiving the data item 125 from the third-party SaaS service 122 (in response to the generated service API request), the SaaS management platform services 127 can provide the data item 125 to the user device 111. In some embodiments, an API request (e.g., platform API call) sent by the user device 111 does not identify a service API call to a third-party SaaS service 122 or corresponding API endpoints 123A-N. In other embodiments, an API request sent by user device 11 does identify a service API call to a third-party SaaS service 122. For example, the user device can directly access a third-party SaaS service 122 using service API calls provided by the third-party service.

In some embodiments, a user device, such as user device 111A, can implement or include one or more applications, such as application 119 (also referred to as “client application” herein) executed at user device 111A. In some embodiments, application 119 can be used to communicate (e.g., send and receive information) with SaaS management platform 120. In some embodiments, application 119 can implement user interfaces (e.g., GUIs) that may be webpages rendered by a web browser and displayed on the user device 111A in a web browser window. In another embodiment, the user interfaces of application 119 may be included in a stand-alone application downloaded to the user device 111A and natively running on the user device 111A (also referred to as a “native application” or “native client application” herein).

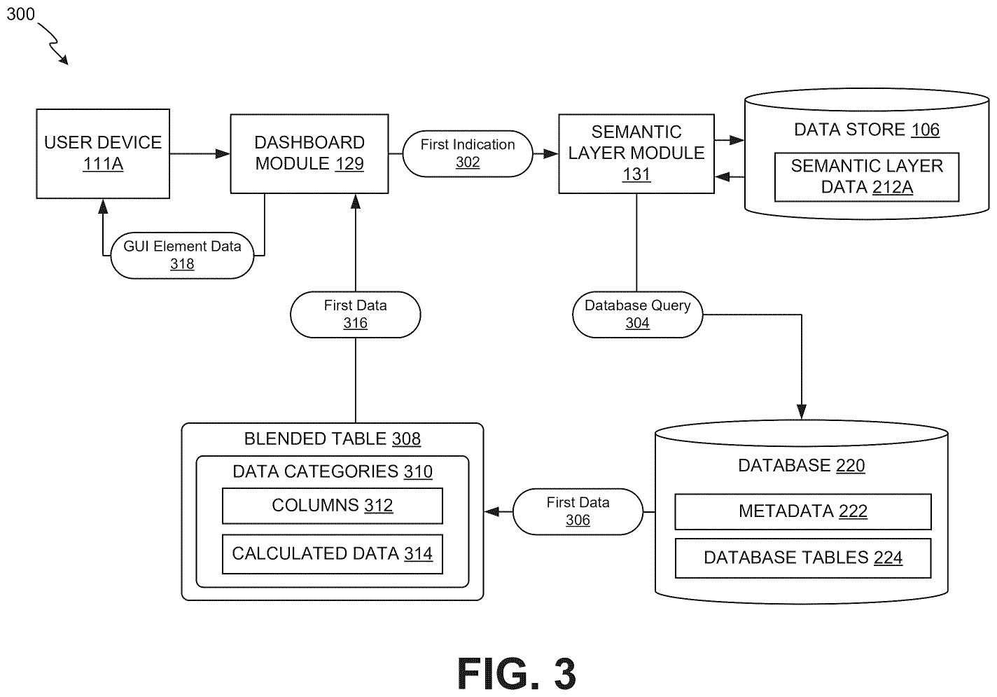

In some embodiments, SaaS management platform services 127 can also include a dashboard module 129. Dashboard module 129 may include hardware and/or software configured to assist rendering a dashboard GUI, as discussed herein. Dashboard module 129 may receive an indication from application 119 of a user device 111A that identifies an initialization of an instance of a GUI. The GUI may include a dashboard GUI, which may include a dashboard capable of displaying one or more visualizations of data (e.g., charts, graphs, tables, etc.) managed by SaaS management platform 120. Dashboard module 129 may use semantic layer module 131 of server 130 to identify data in data store 106 used to generate a visualization of the dashboard GUI and retrieve such data. Semantic layer module 131 may include hardware and/or software configured to identify data used in rendering one or more visualizations of a dashboard GUI and efficiently retrieving and providing such data to dashboard module 129. In some embodiments, semantic layer module 131 (and server 130) can be part of SaaS management platform 120. In some embodiments, the dashboard module 129 can include semantic layer module 131 (e.g., semantic layer sub-module). Details regarding determining and retrieving the data are provided with reference to FIGS. 3-5.

In some embodiments, SaaS management platform 120 or server 130 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components that can be used to provide a user with access to one or more data items 125 of the SaaS management platform 120 (e.g., through SaaS management platform services 127 and/or one or more third-party SaaS services 122) or that can be used to provide a user with a dashboard GUI. The SaaS management platform 120 can also include a website (e.g., a webpage) or application back-end software that can be used to provide user with access to the SaaS management platform 120.

In some embodiments, server 130 can be part of SaaS management platform 120. In other embodiments, server 130 can be separate from SaaS management platform 120 (e.g., provided by a third-party service provider). It should be noted that in some other embodiments, one or more of the functions of SaaS management platform 120 can be provided by a greater number of machines. In addition, the functionality attributed to a particular component of the SaaS management platform 120 can be performed by different or multiple components operating together. As described above, the SaaS management platform 120 can also be accessed as a service provided to other systems or devices through various embodiments of platform API endpoints, and thus is not limited to use in websites. Although embodiments of the disclosure are discussed in terms of SaaS management platforms, embodiments can also be generally applied to any type of platform or service.

In situations in which the systems discussed here collect personal information about users, or can make use of personal information, the users can be provided with an opportunity to control whether or how the SaaS management platform 120 collects user information. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the SaaS management platform 120.

FIG. 2 schematically illustrates an example architecture 200, in accordance with some embodiments of the disclosure. For purposes illustration rather than limitation, architecture 200 (also referred to as “system 200” herein) may include a subset of some components of architecture 100 of FIG. 1. For example, architecture 200 may include network 104, data store 106, user device 111A (including application 119 and graphical user interface (GUI) 230), SaaS management platform 120 (including SaaS management platform services 127 and dashboard module 129), and server 130 (including semantic layer module 131). It can be appreciated that in some embodiments, architecture 200 can include any of the components of architecture 100. For the sake of brevity, the description of elements of FIG. 1 can also apply to the corresponding elements of FIG. 2.

As can be seen in FIG. 2, data store 106 may include semantic layer storage 210. Semantic layer storage 210 may include one or more semantic layer data 212A-M (also referred to herein as semantic layer data 212). Semantic layer data 212 may include data that indicates one or more data categories that can be visualized on a dashboard GUI. Semantic layer module 131 may use semantic layer data 212 to generate one or more database queries that generate a blended table and retrieve data from the blended table to be used to generate a visualization for the dashboard GUI, as explained below in reference to FIGS. 3-5.

In some embodiments, data store 106 may include a database 220. Database 220 may include metadata 222. Database 220 may include structured data, such as one or more database tables 224 that include data organized in a data structure organized in rows and columns. Metadata 222 may include metadata for database 220 or metadata for one or more of the database tables 224. Metadata 222 may include data indicating one or more of: a name or other identifier of a database table of the one or more database tables 224, the columns of the database table, foreign keys used in the database 220, indices, user-defined functions, stored procedures, users of the database 220, user groups, privileges, size data (e.g., the size of the database table, number of rows or columns in the database table, number of records in the database table, etc.), audit data (e.g., session data, query history, etc.), or other metadata. Database tables 224 may include one or more database tables. A database table may include one or more data records that may form the rows of the database table. The database table may include one or more columns organizing the data of the one or more rows.

FIG. 3 schematically illustrates an example dataflow 300 to generate a blended table by using semantic layer data, in accordance with some embodiments of the disclosure. A user of user device 111A may desire to access a dashboard GUI of application 119 in order to see visualizations of data managed by SaaS management platform 120. The user of user device 111A may access a dashboard portion of application 119. User device 111A may initialize an instance of GUI 230, which may include the dashboard GUI. GUI 230 may include one or more GUI elements, and a GUI element of the one or more GUI elements may include a chart, a table, or another type of visualization. User device 111A may provide data to dashboard module 129 indicating the initialization of the GUI 230. Dashboard module 129 of SaaS management platform 120 may provide a first indication 302 to semantic layer module 131. First indication 302 may identify the initialization of the instance of GUI 230.

In one embodiment, responsive to receiving first indication 302, semantic layer module 131 may determine first semantic layer data 212A associated with a first one or more data categories specific to a first GUI element of the one or more GUI elements. The first one or more data categories specific to the first GUI element may include one or more of database columns, metrics, or calculated data that the dashboard module 129 can use to generate the GUI element. In some embodiments, a metric may include a value indicating a measurement about data in database 220. Examples of metrics include the number of rows or columns in a database table 224, a target equity value of client organization 110A, or some other metric. In one embodiment, calculated data may include data that is not stored in database 220 but is derived from data stored in database 220. Examples of calculated data can include average employee salary (where database 220 stored individual employees' salaries), number of employees assigned to a specific location (where database 220 stores the location of individual employees), etc. In one or more embodiments, a metric may include calculated data.

In some embodiments, semantic layer module 131 may identify GUI configuration data. The GUI configuration data may identify the one or more GUI elements of GUI 230 and may configure (or assist in configuring) GUI 230. In some embodiments, the first indication 302 may specify the GUI configuration data. For example, the particular dashboard with a particular user account can be associated with a specific GUI configuration data. GUI configuration data may be stored in data store 106, and semantic layer module 131 may retrieve the GUI configuration data from data store 106.

As an example, GUI 230 may include three GUI elements: GUI element A, GUI element B, and GUI element C. First indication 302 may specify GUI configuration data that identifies GUI element A, GUI element B, and GUI element C. GUI elements A, B, and C can, for example, correspond to separate charts that are presented in the GUI 230. In some embodiments, each of the GUI elements can have a corresponding semantic layer data referenced by the GUI configuration data. The semantic layer can retrieve the respective semantic layer data based on the reference. Semantic layer module 131 may retrieve the specified GUI configuration data from data store 106 (e.g., the GUI configuration data may be stored in a database, and semantic layer module 131 may generate a database query that retrieves the GUI configuration data from data store 106). Semantic layer module 131 may determine or identify, from the GUI configuration data, that first semantic layer data 212A is associated with GUI element A.

In some embodiments, the GUI configuration data can reference the one or more GUI elements that are part of GUI 230. The semantic layer module 131 may use the reference to a GUI element to retrieve the semantic layer data 212A associated with the GUI element. The GUI configuration data can indicate or describe data to be retrieved from database 220, calculated data, or metrics and used to render a GUI element. The GUI configuration data may include one or more database queries configured to retrieve or calculate such data. The GUI configuration data can include other information used to render or display GUI 230.

In one embodiment, to determine the first semantic layer data 212A, semantic layer module 131 can identify the first semantic layer data 212A based on the first indication 302. The first indication 302 may include data identifying the first semantic layer data 212A (e.g., reference to GUI element A). The first semantic layer data 212A may specify the first one or more data categories to generate a database query 304. Semantic layer module 131 may retrieve the first semantic layer data 212A from data store 106, and semantic layer module 131 may use the first one or more data categories identified by the first semantic layer data 212A to generate a database query 304, as discussed below. In some embodiments, the first semantic layer data 212A can specify an API call for a database query to retrieve relevant information (e.g., information of data categories) for the particular GUI element. In some embodiments, the semantic layer data can include a file that specifies an API call (and/or database query) that pertains to a particular GUI element.

In some embodiments, first semantic layer data 212A may specify the first one or more data categories specific to the first GUI element rather than other data categories that are unspecific to the first GUI element. As discussed above, in a conventional data visualization system, the data visualization system retrieves multiple database tables, in their entireties, that contain the data needed to generate a visualization. As such, these database tables contain data unspecific to the visualization. The database tables are then joined together into one large table, and data is retrieved from the large table. In contrast, the aspects and embodiments of the present disclosure specify data categories specific to the first GUI element, and those specified data categories are used to retrieve data to generate a blended table that is smaller than the one large table generated by the conventional data visualization system.

In one or more embodiments, determining the first semantic layer data 212A may include determining the first one or more data categories specific to the first GUI element. For example, as discussed above, semantic layer module 131 may determine that first semantic layer data 212A is associated with the first GUI element, and first semantic layer data 212A may specify the first one or more data categories specific to the first GUI element. In another example, first indication 302 may include data identifying the first one or more data categories. In some embodiments, semantic layer module 131 may identify database metadata 222 corresponding to the first one or more data categories. For example, database metadata 222 may specify, for each database table 224, the columns included in the respective database table 224, and one or more of the columns may correspond to first one or more data categories. Semantic layer module 131 may identify, at runtime and using metadata 222 of database 220, one or more database tables 224 that include the first one or more data categories. Semantic layer module 131 may generate database query 304 to retrieve first data 306 of the first one or more data categories from the identified one or more database tables 224, as discussed below. Thus, in some embodiments, first semantic layer data 212A may not specify which database tables 224 contain first data 306, and semantic layer module 131 may, at runtime, determine the database tables 224 that contain first data 306. This may allow database 220 more flexibility in its schema and does not require first semantic layer data 212A to specify the database tables 224 beforehand.

In one embodiment, semantic layer module 131 may generate a database query 304. Database query 304 may include a database query configured to retrieve, from database 220, first data 306 of the first one or more data categories associated with first semantic layer data 212A. Semantic layer module 131 may cause execution of database query 304. Semantic layer module 131 may obtain first data 306 in response to the execution of database query 304. In some embodiments and as noted above, the first semantic layer data 212A can specify a database query or be used to generate a database query.

Semantic layer module 131 may generate a blended table 308 based on first data 306. Blended table 308 may include first data 306 of first one or more data categories 310 (e.g., related to a GUI element). In some embodiments, first one or more data categories 310 may include one or more columns 312. A column of the one or more columns 312 may include a set of data values of a particular type. A column may include a column stored in a database table of the one or more database tables 224 of database 220. For example, database query 304 may include a query “SELECT id, salary FROM employee WHERE . . . ”, and the one or more columns 312 may include the columns “id” and “salary” and their respective values from the “employee” database table 224 for the database rows that meet the criteria that appears after the “WHERE” clause of database query 304.

In some embodiments, the first one or more data categories 310 may include calculated data 314. Calculated data may include data that semantic layer module 131 (or some other component of system 100) calculates from data stored in database 220. For example, calculated data 314 may include an employee headcount value, and semantic layer module 131 may calculate the value by determining the number of rows in an “employee” database table 224 of database 220.

In one embodiment, blended table 308 may include a table generated by joining columns 312 containing data from multiple database tables 224 of database table 224 and calculated data 314. However, unlike conventional data visualization systems, in some embodiments, blended table 308 may not include a table generated by joining multiple entire database tables 224. As discussed above, the blended table 308 may be smaller in data size, number of columns, or number of rows, than the one large table generated by a conventional data visualization system. In some embodiments, blended table 308 may be stored in a memory (e.g., volatile memory), such as the memory of server 130 or SaaS management platform 120. The amount of memory used to store blended table 308 may be smaller than the amount of memory that would be used to store a similar large table generated by a conventional data visualization system. In some embodiments, the reduced size of the blended table 308 can allow the blended table 308 to be stored in memory, while a conventional static table may be too large to store in memory and is stored in a datastore (which can slow data retrieval).

In some embodiments, database query 304 may include database operations that join the columns 312 and/or the calculated data 314 to create blended table 308. In other embodiments, semantic layer module 131 may cause execution of a second database query that joins the columns 312 and/or the calculated data 314. The second database query may be based on first semantic layer data 212A.

In one or more embodiments, semantic layer module 131 may provide first data 316 from blended table 308 to render the first GUI element of GUI 230 for presentation at user device 111A. Semantic layer module 131 may provide first data 315 to dashboard module 129. First data 316 may include data from blended table 308 in a predetermined format expected by dashboard module 129. Dashboard module 129 may use first data 316 to generate GUI element data 318 that GUI 230 may use to render the first GUI element. In some embodiments, GUI element data 318 may include HTTP data, JavaScript data, or data in some other format that GUI 230 may use to render the first GUI element.

In one embodiment, responsive to receiving first indication 302, semantic layer module 131 may determine second semantic layer data 212B associated with second one or more data categories specific to a second GUI element of the one or more GUI elements. The second GUI element may include a second chart that is different from the first GUI element and may display different data than the first GUI element. Semantic layer module 131 may cause an execution of another database query. Executing the second database query may retrieve second data of the second one or more data categories associated with the second semantic layer data 212B. Semantic layer module 131 may append blended table 308 to include the second data of the second one or more data categories. In some embodiments, appending the second data to blended table 308 may include joining the tables based on join condition. In some embodiments, executing the second query may include joining the second data and blended table 308. Appending the second data to blended table 308 may include combining the second data and blended table 308 in some other way. Semantic layer module 131 may provide the second data from blended table 308 to render the second GUI element of the GUI for presentation at user device 111A. Semantic layer module 131 may provide at least a portion of first data 316 from blended table 308 to render the second GUI element. In this manner, semantic layer module 131 may reuse blended table 308 and retrieve first and second data from blended table 308 for rendering multiple GUI elements without having to regenerate blended table 308 for each GUI element. This reduces the number of operations performed by semantic layer module 131 and database 220, which reduces computer resource usage of SaaS management platform 120 and/or server 130.

As can be seen from the discussion of FIG. 3, above, embodiments of the present disclosure generate blended table 308, which is smaller than the one large table generated by conventional data visualization systems. Thus, SaaS management platform 120 or server 130 use less memory to store blended table 308, and performing operations on blended table 308 are faster and more efficient than conventional data visualization systems. Thus, embodiments of the present disclosure provide advantages and technical improvements over conventional data visualization systems.

As an example of dataflow 300, the first GUI element may include a bar chart that displays the average employee salary per location of client organization 110A (with the x-axis of the chart including the different locations and the y-axis including the average employee salary). A user of user device 111A may use application 119 to initialize an instance of GUI 230, which may include the first GUI element. User device 111A may send dashboard module 129 data indicating that user device 111A has initialized the instance of GUI 230. Dashboard module 129 may send semantic layer module 131 first indication 302.

Continuing the example, semantic layer module 131 may inspect first indication and determine that the first GUI element is associated with GUI 230. Semantic layer module 131 may then determine that first semantic layer data 212A is associated with the first GUI element and, thus, first semantic layer data 212A specifies first one or more data categories used to render the first GUI element. In this example, the first one or more data categories may include employee ID, employee salary, location, and average employee salary per location.

Continuing the example, semantic layer module 131 may generate database query 304 configured to retrieve, from database 220, first data 306 of the first one or more data categories associated with first semantic layer data 212A. Database query 304 may retrieve columns “employeeID” and “employeeSalary” from an “Employee” database table 224 and may retrieve column “location” from a “Location” database table 224. The data category for average employee salary per location may not be stored in a database table 224 and may be calculated. Semantic layer module 131 may cause execution of database query 304 and may obtain first data 306 in response to the execution of database query 304.

Continuing the example, semantic layer module 131 may use first data 306 to calculate the average employee salary per location using the values for the “employeeID,” “employeeSalary,” and “location” columns retrieved from database tables 224. Semantic layer module 131 may then generate blended table 308. Blended table 308 may include a column 312 corresponding to the location data category, and the column 312 may include a value for each unique location retrieved from database tables 224. Blended table 308 may include the calculated data 314 of average employee salary, as calculated by semantic layer module 131, for each location.

Continuing the example, semantic layer module 131 may provide first data 316 from blended table 308 to dashboard module 129 to render the first GUI element of GUI 230 for presentation at user device 111A. First data 316, in this example, may include each location in blended table 308 and the corresponding average employee salary. Dashboard module 129 may use first data 316 to generate GUI element data 318 that GUI 230 may use to render the first GUI element. Dashboard module 129 may send GUI element data 318 to user device 111A, and GUI 230 may render the first GUI element as a bar chart showing average employee salary per location.

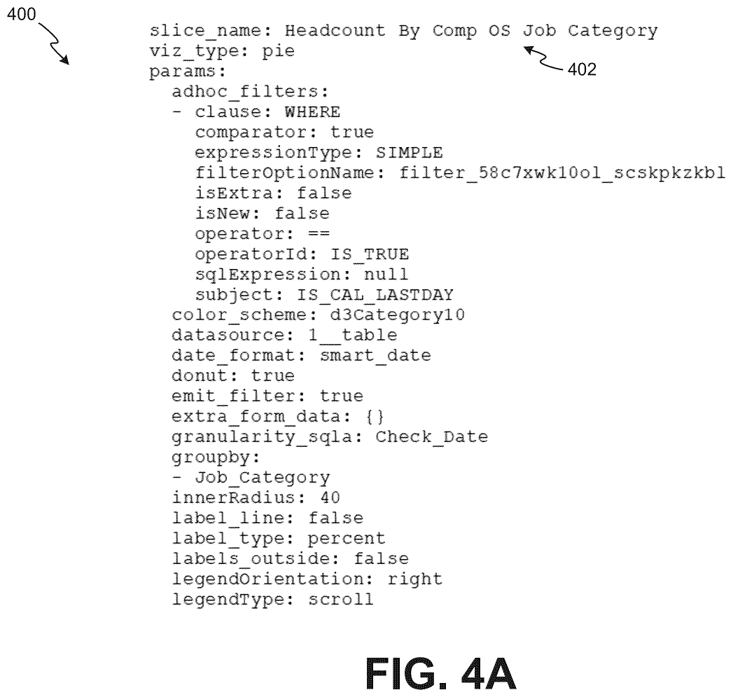

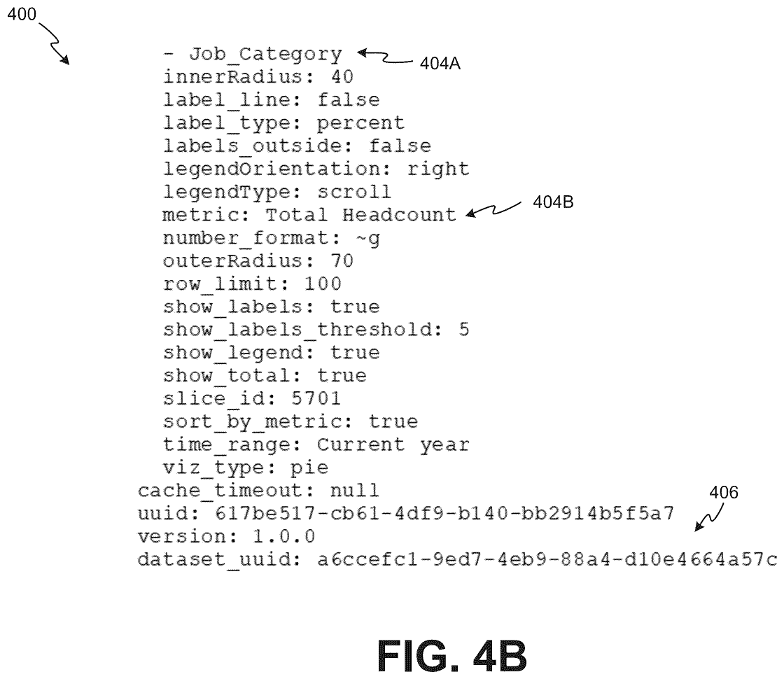

FIGS. 4A-B illustrate example GUI configuration data 400, in accordance with some embodiments of the disclosure. GUI configuration data 400 may include a GUI element name 402. The GUI element name 402 may identify a GUI element. GUI configuration data 400 may include other data associated with the GUI element, including the type of GUI element (bar chart, pie chart, table etc.) or possible filters associated with the data used to render the GUI element. GUI configuration data 400 may include one or more data categories 404A-B used to generate the GUI element. GUI configuration data 400 may include a reference 406 to semantic layer data 212 that semantic layer module 131 may use to retrieve data used in generating the GUI element.

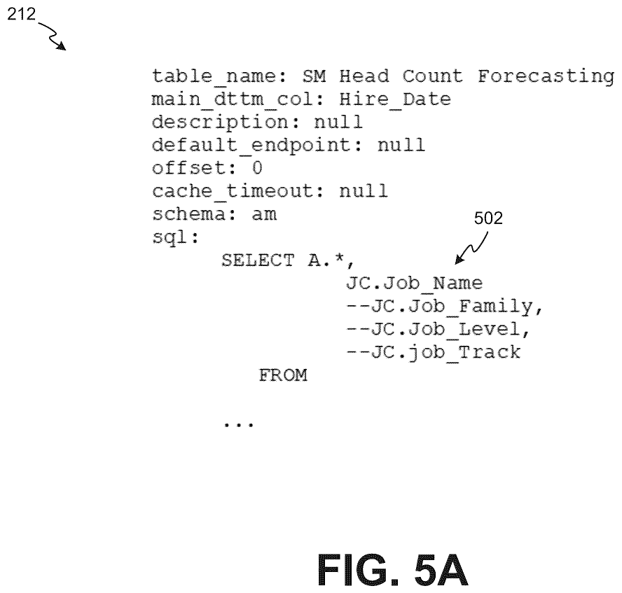

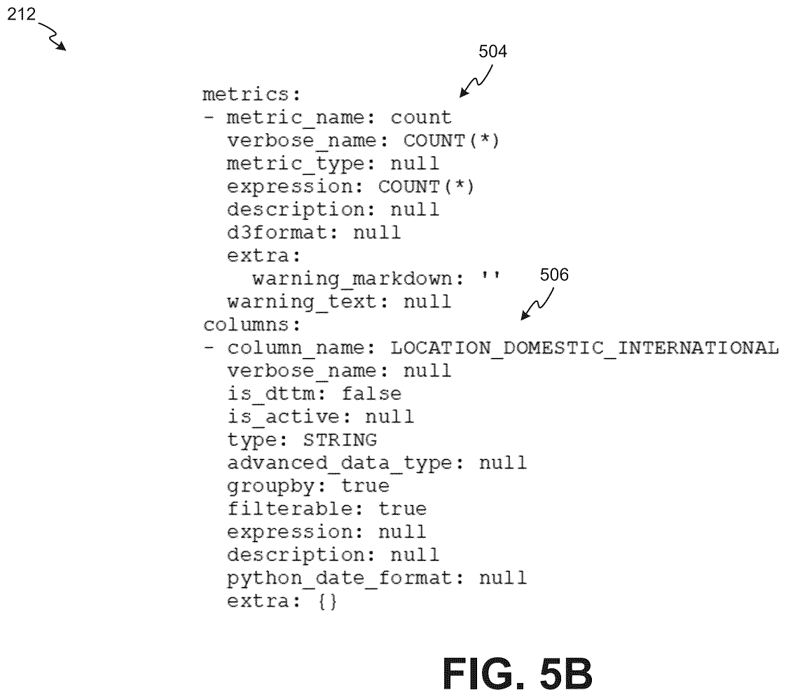

FIGS. 5A-B illustrate example semantic layer data 212, in accordance with some embodiments of the disclosure. In some embodiments, semantic layer data 212 may include a database query 502. The database query 502 may include the database query 304 of FIG. 3, or semantic layer module 131 may use database query 502 to generate database query 304. Semantic layer data 212 may indicate one or more metrics 504. Semantic layer data 212 may indicate one or more database table columns 506. The one or more metrics 504 or database table columns 506 may include the first one or more data categories specific to the GUI element associated with the semantic layer data 212.

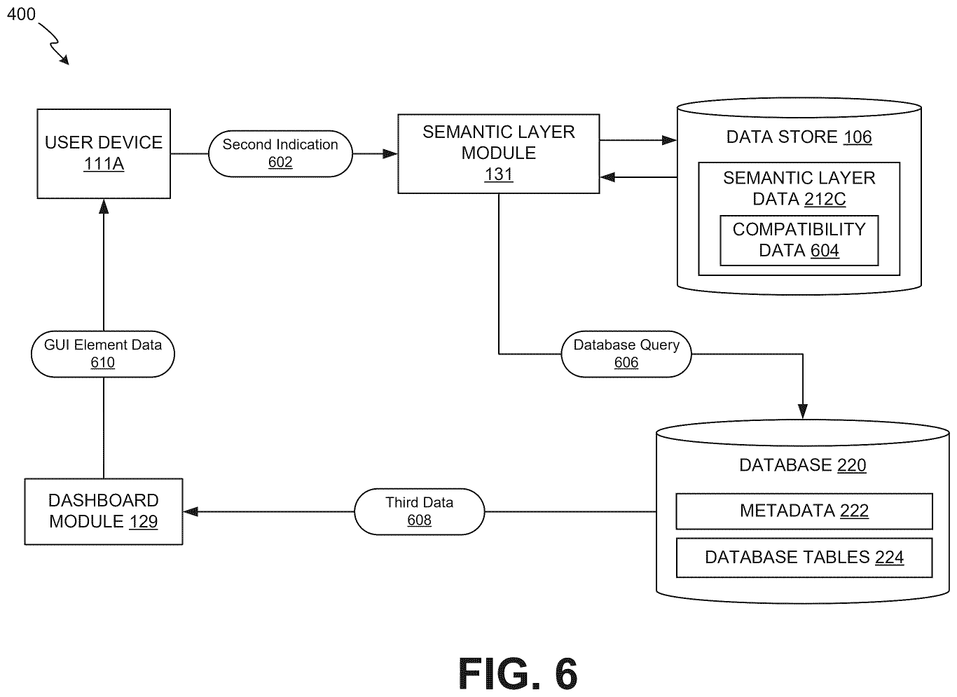

FIG. 6 schematically illustrates an example dataflow 600 to determine data compatibility by using semantic layer data 212, in accordance with some embodiments of the disclosure. User device 111A may provide a second indication 602 to semantic layer module 131. In some embodiments, dashboard module 129 may receive second indication 602, and dashboard module 129 may send second indication 602 to semantic layer module 131.

Semantic layer module 131 may receive second indication 602. Second indication 602 may identify a user request to render a third GUI element of the one or more GUI elements based on one or more user-selected parameters corresponding to a third data category and a fourth data category. In some embodiments, the second indication 602 is received subsequent to initializing the GUI (e.g., GUI 230). In one embodiment, the one or more user-selected parameters may include a filter on at least a portion of the third data category and/or the fourth data category.

Responsive to semantic layer module 131 receiving second indication 602, semantic layer module 131 may determine, by the semantic layer, whether the third data category and the fourth data category are compatible. Determining whether the third data category and the fourth data category are compatible may include retrieving third semantic layer data 212C associated with the third GUI element from data store 106. Retrieving third semantic layer data 212C may be similar to retrieving first semantic layer data 212A based on first indication 302, as discussed above in relation to FIG. 3. Third semantic layer data 212C may include compatibility data 604. Compatibility data 604 may indicate whether the user-selected parameters are compatible with the third data category and/or fourth data category. In some embodiments, the compatibility data can include a whitelist of data categories that are compatible with the third data category. If the fourth data category is part of the whitelist, the third data category and forth data category are determined compatible. If the fourth data category is not part of the whitelist, the third data category and fourth data category are determined incompatible.

Responsive to semantic layer module 131 determining that the third data category and the fourth data category are incompatible, semantic layer module 131 may use the third data category included in the third semantic layer data 212C to generate a database query 606.

Database query 606 may include a database query configured to retrieve, from database 220, third data 608 corresponding to the third data category associated with third semantic layer data 212C. Database query 606 may include a database query configured to not retrieve fourth data corresponding to the fourth data category associated with third semantic layer data 212C. Semantic layer module 131 may cause execution of database query 606. Semantic layer module 131 may obtain third data 608 in response to the execution of database query 606. Third data 608 data may include one or more values corresponding to the third data category. Semantic layer module 131 may not obtain fourth data corresponding to the fourth data category in response to the execution of database query 606.

Semantic layer module 131 may provide third data 608 corresponding to the third data category to dashboard module 129. Semantic layer module 131 may refrain from providing fourth data corresponding to the fourth data category to dashboard module 129. Dashboard module 129 may use third data 608 to generate GUI element data 610 that GUI 230 may use to render the third GUI element for presentation at user device 111A (e.g., rather than displaying no data in the GUI element).

As discussed above, the one or more user-selected parameters may include a filter on a data category. In some embodiments, semantic layer module 131 may generate database query 606 further based on the filter, and the database query 606 may be configured to retrieve third data 608 based on the filter. For example, database query 606 may include a “WHERE” clause that configures database query 606 to retrieve data that meet filter criteria. In one embodiment, database query 606 may retrieve third data 608 without being configured based on the filter, and semantic layer module 131 may apply the filter to third data 608. In one or more embodiments, dashboard module 129 may apply the filter to third data 608, or GUI 230 may apply the filter at the user device 111A.

Responsive to semantic layer module 131 determining that the third data category and the fourth data category are compatible, dataflow 600 may include operations similar to those discussed above in relation to FIG. 3. The semantic layer module 131 may use the third data category and the fourth data category included in the third semantic layer data 212C to generate a database query that is different from database query 606. The database query may include a database query configured to retrieve, from database 220, third data 608 corresponding to the third data category associated with third semantic layer data 212C and fourth data corresponding to the fourth data category associated with third semantic layer data 212C. Semantic layer module 131 may cause execution of the database query. Semantic layer module 131 may obtain third data 608 and fourth data in response to the execution of the database query. Third data 608 data may include one or more values corresponding to the third data category, and fourth data may include one or more values corresponding to the fourth data category. Semantic layer module 131 may generate a blended table 308 based on the third data and fourth data values, and dashboard module 129 may obtain data from the blended table 308 to generate the GUI element data 610 that GUI 230 may use to render the third GUI element for presentation at user device 111A.

As can be seen from the discussion of FIG. 6, above, embodiments of the present disclosure provide third data 608 to dashboard module 129, which provides GUI element data 610 to user device 111A and allows the third GUI element to render, even when one or more user-selected parameters corresponding to a third data category and a fourth data category are incompatible. Conventional data visualization systems, on the other hand, responsive to encountering user-selected parameters corresponding to a third data category and a fourth data category that are incompatible, would generate an error and would not render the third GUI element. Thus, embodiments of the present disclosure provide advantages and technical improvements over conventional data visualization systems.

As an example of dataflow 600, the third GUI element may include a bar chart, and the bar chart may depict employee headcount each month for the past 12 months and a predicted employee headcount each month for the subsequent 6 months for client organization 110A. User device 111A may provide a second indication 602 to semantic layer module 131, and semantic layer module 131 may receive second indication 602. Second indication 602 may identify a user request to render the third GUI element (e.g., re-render the third GUI element with user-selected parameters). Second indication 602 may include one or more user-selected parameters corresponding to a third data category and a fourth data category. The third data category may include employee headcount per month for the past 12 months, and the fourth data category may include predicted employee headcount per month for the next 6 months. The one or more user-selected parameters may include a filter configured to restrict the past employee headcount per month and the predicted employee headcount per month to a specified location of client organization 110A.

Continuing the example, responsive to semantic layer module 131 receiving second indication 602, semantic layer module 131 may determine, by the semantic layer, whether the third data category and the fourth data category are compatible. Semantic layer module 131 may retrieve third semantic layer data 212C associated with the third GUI element from data store 106. Third semantic layer data 212C may include compatibility data 604 indicating that the employee headcount per month data category is incompatible with the predicted employee headcount per month data category when the data categories are subjected to the location filter.

Continuing the example, semantic layer module 131 may determine that the past employee headcount per month data category is incompatible with the predicted employee headcount per month data category when the data categories are subjected to the location filter. In response to this determination, semantic layer module 131 may use the past employee headcount per month data category to generate a database query 606. Database query 606 may include a database query configured to retrieve, from database 220, the values for employee headcount per month data as third data 608. Database query 606 may be configured to not retrieve predicted employee headcount per month data. Database query 606 may be configured to filter the values by the location specified in the one or more user-selected parameters. Semantic layer module 131 may cause execution of database query 606. Semantic layer module 131 may obtain third data 608 in response to the execution of database query 606.

Continuing the example, semantic layer module 131 may provide third data 608 corresponding to the third data category to dashboard module 129. Semantic layer module 131 may refrain from providing fourth data corresponding to the fourth data category to dashboard module 129. Dashboard module 129 may use third data 608 to generate GUI element data 610 that GUI 230 may use to render the third GUI element for presentation at user device 111A.

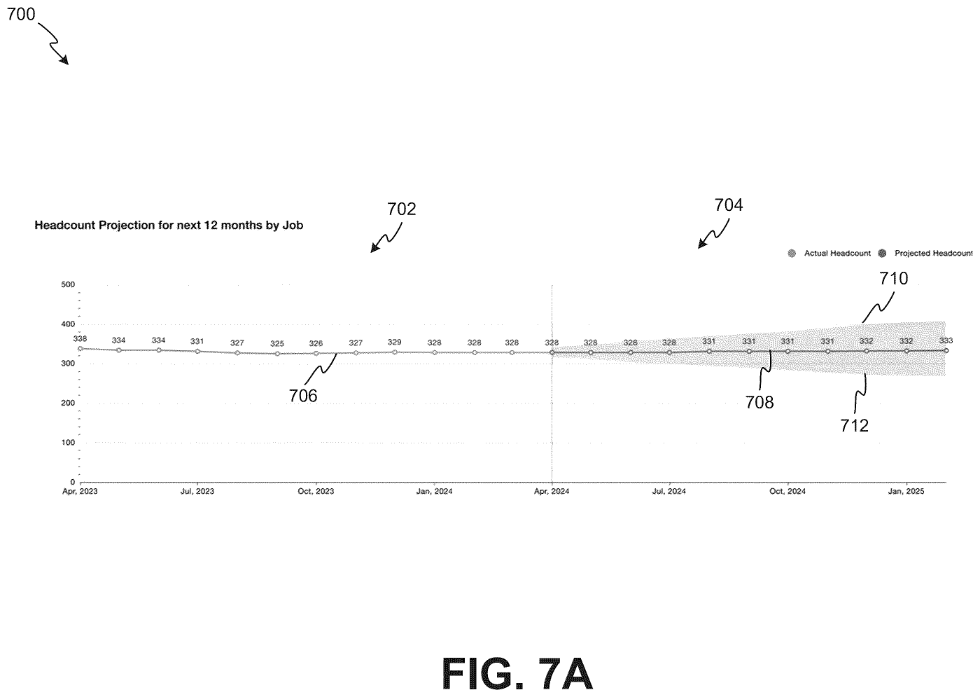

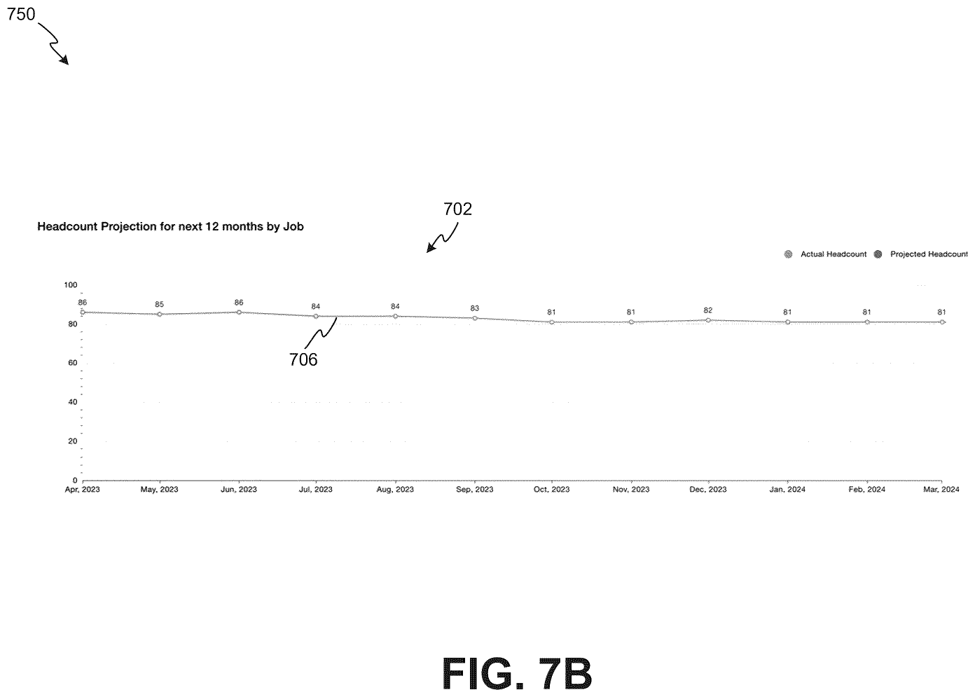

FIG. 7A depicts a UI illustrating an example GUI element 700, in accordance with some embodiments of the disclosure. The GUI element 700 may include a line chart displaying employee headcount information for a client organization 110A. The GUI element 700 may include two portions: a first portion 702 that indicates an actual employee headcount for a previous time interval (in the example of FIG. 7A, from April 2023 to April 2024), and a second portion 704 that indicates a projected employee headcount for a future time interval (in the example of FIG. 7A, from April 2024 to February 2025). The first portion 702 may include a line 706 rendered from values corresponding to an actual employee headcount data category. The second portion 704 may include a first line 708 rendered from values corresponding to a projected employee headcount data category, a second line 710 rendered from values corresponding to an upper projected employee headcount data category (indicating the maximum projected headcount value for the corresponding month), and a third line 712 rendered from values corresponding to a lower projected employee headcount data category (indicating the minimum estimated headcount value for the corresponding month). Semantic layer module 131 may have used compatibility data 604 to determine that the actual employee headcount, the projected employee headcount, upper projected employee headcount, and lower projected employee headcount data categories are compatible; generate one or more database queries 606 to retrieve or calculate the values corresponding to those data categories; and cause the dashboard module 129 to generate the GUI element data 610 used to render the GUI element 700.

FIG. 7B depicts another UI illustrating the example GUI element 700, in accordance with some embodiments of the present disclosure. Similar to the GUI element 700 of FIG. 7B, the GUI element 700 includes a line chart a line chart displaying employee headcount information for a client organization 110A. However, in this example, the user may have selected, using the GUI 230 in which the GUI element 700 is included, a user-selected parameter in the form of a filter (e.g., a filter to only show employee headcount for a certain race). The semantic layer module 131 may receive an indication 602 that includes the user-selected parameter. Semantic layer module 131 may use the compatibility data 604 associated with the semantic layer data 212 that is associated with the GUI element 700 to determine whether the actual employee headcount data category, the projected employee headcount data category, the upper projected employee headcount data category, and the lower projected employee headcount data category are compatible when used with the filter. Responsive to the compatibility data 604 indicating that the data categories are incompatible when used with the filter, semantic layer module 131 may use the actual employee headcount data category included in the semantic layer data 212 to generate a database query 606. Database query 606 may retrieve, from database 220, data corresponding to the actual employee headcount data category and may filter based on the user-selected parameter. Database query 606 may include a database query configured to not retrieve data corresponding to the projected employee headcount data category, the upper projected employee headcount data category, and the lower projected employee headcount data category. Semantic layer module 131 may cause execution of database query 606 and obtain values corresponding to the actual employee headcount data category. Semantic layer module 131 may provide the values to dashboard module 129 to generate GUI element data 610 for rendering the GUI element 700.

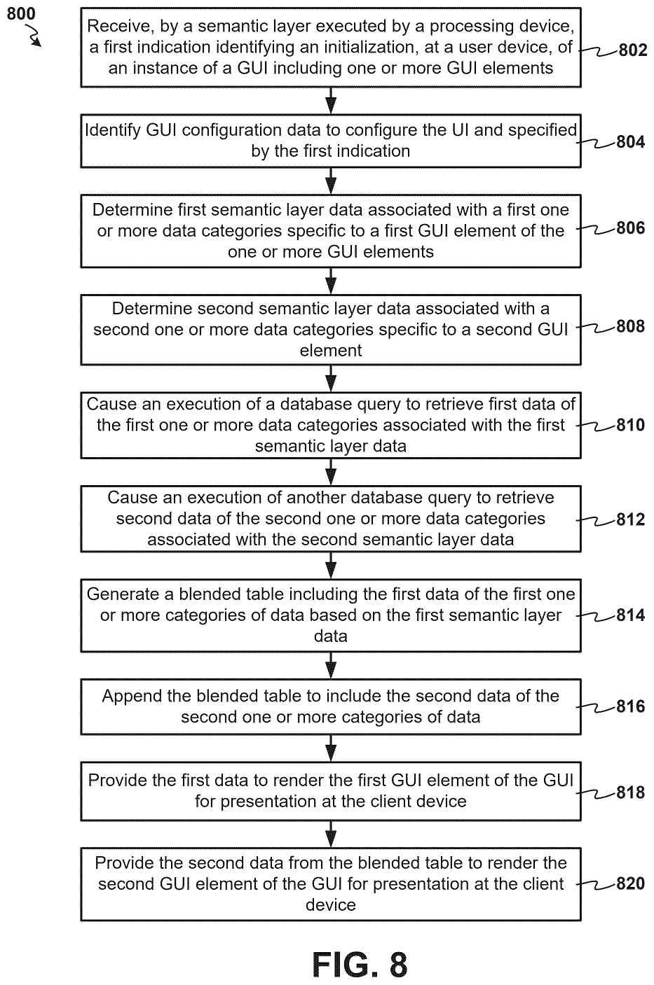

FIG. 8 depicts a flowchart illustrating an example method 800 for practicing some embodiments of the disclosure. The method 800 may include a method for an improved semantic layer for data visualization systems. The method 800, or its individual functions, routines, subroutines, or operations can be performed by a processing device, having one or more processing units (CPUs) and memory devices communicatively coupled to the CPU(s). In some embodiments, the method 800 can be performed by a single processing thread or alternatively by two or more processing threads, each thread executing one or more individual functions, routines, subroutines, or operations of the methods. The method 800, as described below, can be performed by processing logic that can include hardware (e.g., a processing device, circuitry, dedicated logic, programmable logic, microcode, hardware of a device, integrated circuit, etc.), software (e.g., instructions run or executed on a processing device), or a combination thereof. In some embodiments, the method 800 may be performed by one or more of SaaS management platform 120, server 130, or semantic layer module 131, described in FIG. 1. Although shown in a particular sequence or order, unless otherwise specified, the order of the operations can be modified. Thus, the illustrated embodiment should be understood only as an example, and the illustrated operations can be performed in a different order, while some operations can be performed in parallel. Additionally, one or more operations can be omitted in some embodiments. Thus, not all illustrated operations are required in every embodiment, and other process flows are possible. In some embodiments, the same, different, fewer, or greater operations can be performed. It may be noted that elements of FIG. 1 or FIG. 2, or operations described in relation to FIG. 3, or FIG. 6, may be used herein to help describe FIG. 8.

At operation 802, processing logic receives, by a semantic layer executed by a processing device, first indication 302. First indication 302 may identify an initialization, at user device 111A, of an instance of GUI 230. GUI 230 may include one or more GUI elements. For example, as discussed above, operation 810 may include semantic layer module 131 receiving first indication 302 from dashboard module 129 responsive to user device 111A sending an indication to dashboard module 129 regarding initialization of GUI 230. In some embodiments, a GUI element of the one or more GUI elements may include a chart or a table.

At operation 804, responsive to receiving the first indication 302, processing logic identifies GUI configuration data to configure the GUI 230 specified by the first indication 302. The GUI configuration data may identify the one or more GUI elements of the GUI 230.

At operation 806, responsive to receiving first indication 302, processing logic determines first semantic layer data 212A associated with a first one or more data categories specific to a first GUI element of the one or more GUI elements. For example, operation 820 may include identifying first semantic layer data 212A based on first indication 302. In another example, operation 820 may include determining the first one or more data categories specific to the first GUI element, identifying database metadata 222 corresponding to the first one or more data categories, identifying, at runtime using metadata 222 of database 220, one or more database tables 224 that include the first one or more data categories, and generating database query 304 to retrieve first data 306 of the first one or more data categories from the identified one or more database tables 224.

In one embodiment, the first semantic layer data 212A may specify the first one or more data categories specific to the first GUI element, rather than other data categories that are unspecific to the first GUI element. In some embodiments, determining the first semantic layer data 212A may include identifying the first semantic layer data 212A based on the first indication 302, and the first semantic layer may specify the first one or more data categories to generate the database query 304 of operation 810, below. In one or more embodiments, determining the first semantic layer data 212A may include determining the first one or more data categories specific to the first GUI element; identifying database metadata 222 corresponding to the first one or more data categories; identifying, at runtime using metadata 222 of a database 220, one or more database tables 224 that include the first one or more data categories; and generating the database query 304 to retrieve the first data of the first one or more data categories from the identified one or more database tables 224.

At operation 808, responsive to receiving the first indication 302, processing logic determines second semantic layer data 212B associated with second one or more data categories specific to a second GUI element of the one or more GUI elements.

At operation 810, processing logic causes an execution of database query 304 to retrieve first data 306 of the first one or more data categories associated with first semantic layer data 212A. Database query 304 may include a database query configured to retrieve, from database 220, first data 306 of the first one or more data categories associated with first semantic layer data 212A. Semantic layer module 131 may cause execution of database query 304. Semantic layer module 131 may obtain first data 306 in response to the execution of database query 304.

At operation 812, processing logic causes an execution of another database query to retrieve second data of the second one or more data categories associated with the second semantic layer data 212B.

At operation 814, processing logic generates blended table 308. Blended table 308 may include first data 306 of the first one or more data categories based on first semantic layer data 212A. First data 306 may be included in one or more columns 312 or calculated data 314 of blended table 308. As discussed above, blended table 308 is smaller than the one large table generated using conventional data visualization systems.

At operation 816, processing logic appends the blended table 308 to include the second data of the one or more data categories based on the second semantic layer data 212B.

At operation 818, processing logic provides first data 316 from blended table 308 to render the first GUI element of GUI 230 for presentation at user device 111A. Semantic layer module 131 may provide first data 315 to dashboard module 129. First data 316 may include data from blended table 308 in a predetermined format expected by dashboard module 129. Dashboard module 129 may use first data 316 to generate GUI element data 318 that GUI 230 may use to render the first GUI element.

At operation 820, processing logic provides the second data from the blended table 308 to render the second GUI element of the GUI 230 for presentation at the user device 111A.

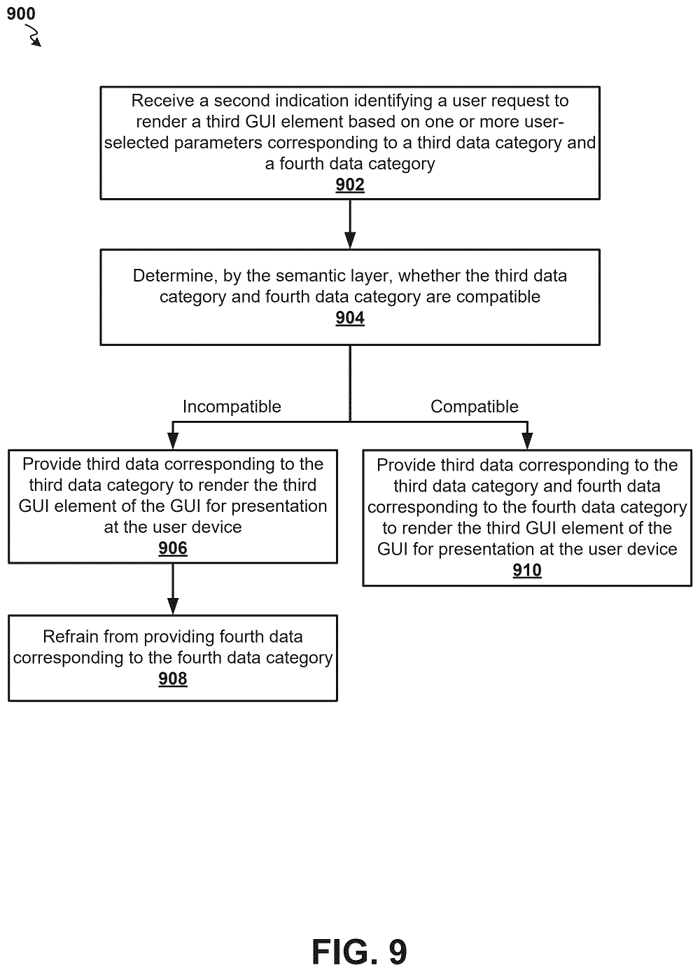

FIG. 9 depicts a flowchart illustrating an example method 900 for practicing some embodiments of the disclosure. The method 900 may include a method for an improved semantic layer for data visualization systems. The method 900, or its individual functions, routines, subroutines, or operations can be performed by a processing device, having one or more processing units and memory devices communicatively coupled to the CPU(s). In some embodiments, the method 900 can be performed by a single processing thread or alternatively by two or more processing threads, each thread executing one or more individual functions, routines, subroutines, or operations of the methods. The method 900, as described below, can be performed by processing logic that can include hardware (e.g., a processing device, circuitry, dedicated logic, programmable logic, microcode, hardware of a device, integrated circuit, etc.), software (e.g., instructions run or executed on a processing device), or a combination thereof. In some embodiments, the method 900 may be performed by one or more of SaaS management platform 120, server 130, or semantic layer module 131, described in FIG. 1. Although shown in a particular sequence or order, unless otherwise specified, the order of the operations can be modified. Thus, the illustrated embodiment should be understood only as an example, and the illustrated operations can be performed in a different order, while some operations can be performed in parallel. Additionally, one or more operations can be omitted in some embodiments. Thus, not all illustrated operations are required in every embodiment, and other process flows are possible. In some embodiments, the same, different, fewer, or greater operations can be performed. It may be noted that elements of FIG. 1 or FIG. 2, or operations described in relation to FIG. 3, or FIG. 6, may be used herein to help describe FIG. 9.

At operation 902, processing logic receives a second indication 602 identifying a user request to render a third GUI element of the one or more GUI elements based on one or more user-selected parameters corresponding to a third data category and a fourth data category.

At operation 904, responsive to receiving the second indication 602, processing logic determines, by the semantic layer, whether the third data category and the fourth data category are compatible. Semantic layer module 131 may use compatibility data 604 associated with third semantic layer data 212C to determine the compatibility of the third data category and the fourth data category.

Responsive to the third data category and the fourth data category being incompatible, at operation 906, processing logic provides third data 608 corresponding to the third data category to render the third GUI element of the GUI 230 for presentation at the user device 111A. At operation 908, processing logic refrains from providing fourth data corresponding to the fourth data category.

Responsive to the third data category and the fourth data category being compatible, at operation 910, processing logic provides the third data 608 and fourth data corresponding to the fourth data category to render the third GUI element of the GUI 230 for presentation at the user device 111A.

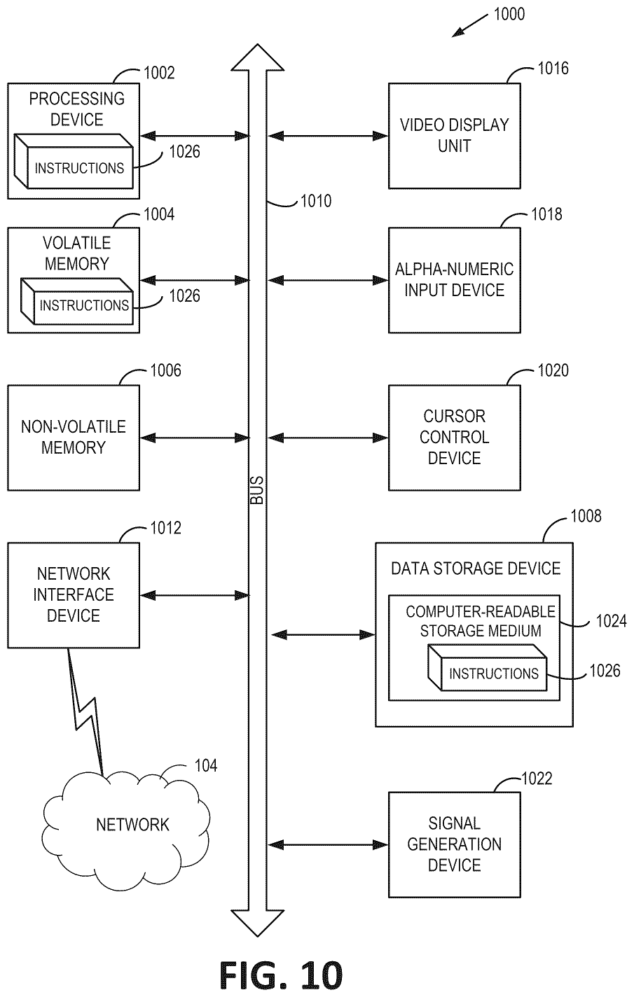

FIG. 10 is a block diagram illustrating an example computer system 1000, in accordance with some embodiments of the disclosure. The computer system can be a computing device or other device discussed herein. The computer system 1000 can be user device 111, SaaS management platform 120, or server 130 of FIG. 1. The computer system 1000 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processing device 1002, a volatile memory 1004 (e.g., read-only memory (ROM), flash memory, dynamic random access memory (DRAM) such as synchronous DRAM (SDRAM), double data rate (DDR SDRAM), or DRAM (RDRAM), etc.), a non-volatile memory 1006 (e.g., flash memory, static random access memory (SRAM), etc.), and a data storage device 1016, which communicate with each other via a bus 1030.

The processing device 1002 represents one or more general-purpose processing devices such as a microprocessor, CPU, GPU, or the like. More particularly, the processing device 1002 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1002 can also be one or more special-purpose processing devices such as an ASIC, a field programmable gate array (FPGA), a digital signal processor (DSP), network processor, or the like. The processing device 1002 is configured to execute instructions 1026 (e.g., for performing method 800 or 900) for performing the operations discussed herein.

The computer system 1000 can further include a network interface device 1008. The network interface device 1008 can assist in data communication between computing devices. The computer system 1000 also can include a video display unit 1010 (e.g., a liquid crystal display (LCD) or a cathode ray tube (CRT)), an input device 1012 (e.g., a keyboard, and alphanumeric keyboard, a motion sensing input device, touch screen), a cursor control device 1014 (e.g., a mouse), and a signal generation device 1018 (e.g., a speaker).

The data storage device 1016 can include a non-transitory machine-readable storage medium 1024 (also computer-readable storage medium) on which is stored one or more sets of instructions 1026. The instructions may embody any one or more of the methodologies or functions described herein. The instructions 1026 can also reside, completely or at least partially, within the volatile memory 1004 and/or within the processing device 1002 during execution thereof by the computer system 1000, the volatile memory 1004 and the processing device 1002 also constituting machine-readable storage media. The instructions 1026 can further be transmitted or received over a network 104 via the network interface device 1008.

In one embodiment, the instructions 1026 include instructions for an improved semantic layer for data visualization systems. While the computer-readable storage medium 1024 (machine-readable storage medium) is shown in an example embodiment to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure can be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving,” “identifying,” “determining,” “causing,” “generating,” “providing,” “appending,” “refraining,” “using,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

For simplicity of explanation, the dataflows 400 and 600 and the methods 800 and 900 are depicted and described herein as a series of acts. However, acts in accordance with this disclosure can occur in various orders and/or concurrently, and with other acts not presented and described herein. Furthermore, not all illustrated acts can be required to implement the dataflows and methods in accordance with the disclosed subject matter. In addition, those skilled in the art will understand and appreciate that the dataflows and methods could alternatively be represented as a series of interrelated states via a state diagram or events. Additionally, it should be appreciated that the dataflows and methods disclosed in this specification are capable of being stored on one or more articles of manufacture to facilitate transporting and transferring such dataflows and methods to computing devices. The term article of manufacture, as used herein, is intended to encompass a computer program accessible from any computer-readable device or storage media.

Certain embodiments of the present disclosure also relate to an apparatus for performing the operations herein. This apparatus can be constructed for the intended purposes, or it can comprise a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

Reference throughout this specification to “one implementation,” “an implementation,” “some implementations,” “one embodiment,” “an embodiment,” or “some embodiments” mean that a particular feature, structure, or characteristic described in connection with the implementation or embodiment is included in at least one implementation or embodiment. Thus, the appearances of the phrase “in one implementation” or “in an implementation” or other similar terms in various places throughout this specification are not necessarily all referring to the same implementation. In addition, the term “or” is intended to mean an inclusive “or” rather than an exclusive “or.” Moreover, the word “example” or a similar term are used herein to mean serving as an example, instance, or illustration. Any aspect or design described herein as an “example” is not necessarily to be construed as preferred or advantageous over other aspects or designs. Rather, use of the word “example” or a similar term is intended to present concepts in a concrete fashion.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A method, comprising:
receiving, by a semantic layer executed by a processing device, a first indication identifying an initialization, at a user device, of an instance of a graphical user interface (GUI) comprising one or more GUI elements;
responsive to receiving the first indication, determining first semantic layer data associated with a first one or more data categories specific to a first GUI element of the one or more GUI elements;
causing an execution of a database query to retrieve first data of the first one or more data categories associated with the first semantic layer data;
generating a blended table comprising the first data of the first one or more data categories based on the first semantic layer data; and
providing the first data from the blended table to render the first GUI element of the GUI for presentation at the user device.

2. The method of claim 1, wherein the first semantic layer data specifies the first one or more data categories specific to the first GUI element, rather than other data categories that are unspecific to the first GUI element.

3. The method of claim 1, further comprising:
responsive to receiving the first indication, determining second semantic layer data associated with a second one or more data categories specific to a second GUI element of the one or more GUI elements;
causing an execution of another database query to retrieve second data of the second one or more data categories associated with the second semantic layer data;
appending the blended table to include the second data of the second one or more data categories based on the second semantic layer data; and
providing the second data from the blended table to render the second GUI element of the GUI for presentation at the user device.

4. The method of claim 1, further comprising: responsive to receiving the first indication, identifying GUI configuration data to configure the GUI specified by the first indication, the GUI configuration data identifying the one or more GUI elements of the GUI.

5. The method of claim 1, further comprising:
receiving a second indication identifying a user request to render a third GUI element of the one or more GUI elements based on one or more user-selected parameters corresponding to a third data category and a fourth data category;
responsive to receiving the second indication, determining, by the semantic layer, whether the third data category and the fourth data category are compatible; and
responsive to determining that the third data category and the third data category are incompatible,
providing third data corresponding to the third data category to render the third GUI element of the GUI for presentation at the user device, and
refraining from providing fourth data corresponding to the fourth data category.

6. The method of claim 1, wherein a GUI element of the one or more GUI elements comprises at least one of a chart or a table.

7. The method of claim 1, wherein determining the first semantic layer data comprises identifying the first semantic layer data based on the first indication, wherein the first semantic layer data specifies the first one or more data categories to generate the database query.

8. The method of claim 1, wherein determining the first semantic layer data comprises:
determining the first one or more data categories specific to the first GUI element;
identifying database metadata corresponding to the first one or more data categories;
identifying, at runtime using metadata of a database, one or more database tables that include the first one or more data categories; and
generating the database query to retrieve the first data of the first one or more data categories from the identified one or more database tables.

9. A system, comprising:
a memory; and
a processing device, coupled to the memory, configured to perform operations comprising:
receiving, by a semantic layer executed by a processing device, a first indication identifying an initialization, at a user device, of an instance of a graphical user interface (GUI) comprising one or more GUI elements,
responsive to receiving the first indication, determining first semantic layer data associated with a first one or more data categories specific to a first GUI element of the one or more GUI elements,
causing an execution of a database query to retrieve first data of the first one or more data categories associated with the first semantic layer data, generating a blended table comprising the first data of the first one or more data categories based on the first semantic layer data, and
providing the first data from the blended table to render the first GUI element of the GUI for presentation at the user device.

10. The system of claim 9, wherein the first semantic layer data specifies the first one or more data categories specific to the first GUI element, rather than other data categories that are unspecific to the first GUI element.

11. The system of claim 9, where the operations further comprise:
responsive to receiving the first indication, determining second semantic layer data associated with a second one or more data categories specific to a second GUI element of the one or more GUI elements;
causing an execution of another database query to retrieve second data of the second one or more data categories associated with the second semantic layer data;
appending the blended table to include the second data of the second one or more data categories based on the second semantic layer data; and
providing the second data from the blended table to render the second GUI element of the GUI for presentation at the user device.

12. The system of claim 9, wherein the operations further comprise: responsive to receiving the first indication, identifying GUI configuration data to configure the GUI specified by the first indication, the GUI configuration data identifying the one or more GUI elements of the GUI.

13. The system of claim 9, wherein the operations further comprise:
receiving a second indication identifying a user request to render a third GUI element of the one or more GUI elements based on one or more user-selected parameters corresponding to a third data category and a fourth data category;
responsive to receiving the second indication, determining, by the semantic layer, whether the third data category and the fourth data category are compatible; and
responsive to determining that the third data category and the third data category are incompatible,
providing third data corresponding to the third data category to render the third GUI element of the GUI for presentation at the user device, and
refraining from providing fourth data corresponding to the fourth data category.

14. The system of claim 9, wherein a GUI element of the one or more GUI elements comprises at least one of a chart or a table.

15. The system of claim 9, wherein determining the first semantic layer data comprises identifying the first semantic layer data based on the first indication, wherein the first semantic layer data specifies the first one or more data categories to generate the database query.

16. The system of claim 9, wherein determining the first semantic layer data comprises:
determining the first one or more data categories specific to the first GUI element;
identifying database metadata corresponding to the first one or more data categories;
identifying, at runtime using metadata of a database, one or more database tables that include the first one or more data categories; and
generating the database query to retrieve the first data of the first one or more data categories from the identified one or more database tables.

17. A non-transitory computer-readable storage medium comprising instructions that, responsive to execution by a processing device, cause the processing device to perform operations comprising:
receiving, by a semantic layer executed by a processing device, a first indication identifying an initialization, at a user device, of an instance of a graphical user interface (GUI) comprising one or more GUI elements,
responsive to receiving the first indication, determining first semantic layer data associated with a first one or more data categories specific to a first GUI element of the one or more GUI elements,
causing an execution of a database query to retrieve first data of the first one or more data categories associated with the first semantic layer data,
generating a blended table comprising the first data of the first one or more data categories based on the first semantic layer data, and
providing the first data from the blended table to render the first GUI element of the GUI for presentation at the user device.

18. The computer-readable storage medium of claim 17, wherein the first semantic layer data specifies the first one or more data categories specific to the first GUI element, rather than other data categories that are unspecific to the first GUI element.

19. The computer-readable storage medium of claim 17, where the operations further comprise:
responsive to receiving the first indication, determining second semantic layer data associated with a second one or more data categories specific to a second GUI element of the one or more GUI elements;
causing an execution of another database query to retrieve second data of the second one or more data categories associated with the second semantic layer data;
appending the blended table to include the second data of the second one or more data categories based on the second semantic layer data; and
providing the second data from the blended table to render the second GUI element of the GUI for presentation at the user device.

20. The computer-readable storage medium of claim 17, wherein the operations further comprise: responsive to receiving the first indication, identifying GUI configuration data to configure the GUI specified by the first indication, the GUI configuration data identifying the one or more GUI elements of the GUI.
